(19) United States
(12) Patent Application Publication
(10) Pub. No.: US 2007/0141903 A1
(43) Pub. Date: Jun. 21, 2007

(54) Electrical connector assembly

(76) Inventors: Paul G. Casperson, Peoria, IL (US); David C. Freeman, Mapleton, IL (US)

Correspondence Address: Caterpillar Inc.;Intellectual Property Dept., AB 6490, 100 N.E. Adams Street, PEORIA, IL, 61629-6490, US

(21) Appl. No.: 11/311,596

(22) Filed: Dec. 19, 2005

(51) Int. Cl. H01R 9/05

(52) U.S. Cl. 439/582

(57) ABSTRACT

An electrical connector assembly. The connector may include a top housing and base housing for a conductor. The base housing may include a base conductor channel extending along a longitudinal axis, a conductor partition, and at least one conductor contact having corresponding prong transverse the longitudinal axis. The top housing may include a top conductor channel corresponding to the base conductor channel and a connector interface operably connected to the at least one prong.

### TECHNICAL FIELD

The present invention relates generally to connectors and more particularly to electrical connector assemblies.

### BACKGROUND

Connectors are well known in the art for establishing electrical connection between electronic devices. While many types of connectors are adequate for certain applications, there are situations in which existing connectors do not function as well as described. For example, in many applications where a conductor is already present, there may be a need to add a new connector to connect new devices for new applications. Unfortunately, each new electrical connection is a point of potential failure and interrupting the conductor with numerous electrical connections may significantly increase electrical resistance.

In certain applications, such as where machines are powered, controlled and monitored using electric and electronic technology, electrical conductors may supply power and data to various components and locations, and connectors may be required to convey power and data to attached devices. Attempts have been made to attach connectors to a conductor where both power and data are routed over the same conductor. One such example is disclosed in U.S. Pat. No. 6,179,644 to Adams et al (hereinafter “Adams”). Adams discloses attaching a connector to a conductor that routes power and data signals over separate power and data wires. Unfortunately, the connector of Adams may not provide an adequate electrical connection due to reliance on the precision and penetration of prongs through the conductor sheathing as the connector is assembled.

### SUMMARY OF THE INVENTION

It is to be understood that both the foregoing general description and the following detailed description are exemplary and explanatory only and are not restrictive of the invention as claimed.

One aspect of the present invention is directed to a connector having a base housing and a top housing. The base housing has a longitudinal axis and includes a base conductor channel, a conductor partition and at least one conductor contact. The base conductor extends along the longitudinal axis and provides a through path for a power and data delivery conductor. The at least one conductor contact has at least one corresponding prong extending transverse the longitudinal axis. The top housing includes a top conductor channel and a connector interface. The top conductor channel corresponds to the base conductor channel. The connector interface is operably connected to the at least one connector pin.

Another aspect of the present invention is directed to a method for attaching a connector to a conductor. The method includes attaching a conductor contact to each of at least one conductor wires, the conductor contact having a prong extending transverse a longitudinal axis of the conductor, positioning the conductor in a base conductor channel of a base housing located along the longitudinal axis, separating each conductor wire with a conductor partition, and attaching a top housing to the base housing such that each prong extends through the top housing to a connector interface.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is a perspective view of a connector according to one embodiment of the present disclosure;

FIG. 2 is a perspective view of the connector in FIG. 1 with a connector top housing removed;

FIG. 3 is a perspective view of the connector in FIG. 1 with a connector top housing and a circuit board removed;

FIG. 4 is a perspective view of the connector in FIG. 1 with a connector top housing, circuit board and potting layer removed;

FIG. 5 is a perspective view of the connector of FIG. 1 with a connector base housing removed;

FIG. 6 is a cross section diagram of the connector of FIG. 1 parallel to the conductor; and

FIG. 7 is a cross section diagram of the connector of FIG. 1 perpendicular to the conductor.

### DETAILED DESCRIPTION

Reference will now be made in detail to embodiments of the invention, examples of which are illustrated in the accompanying drawings. Whenever possible, the same reference numbers will be used throughout the drawings to refer to the same or like parts.

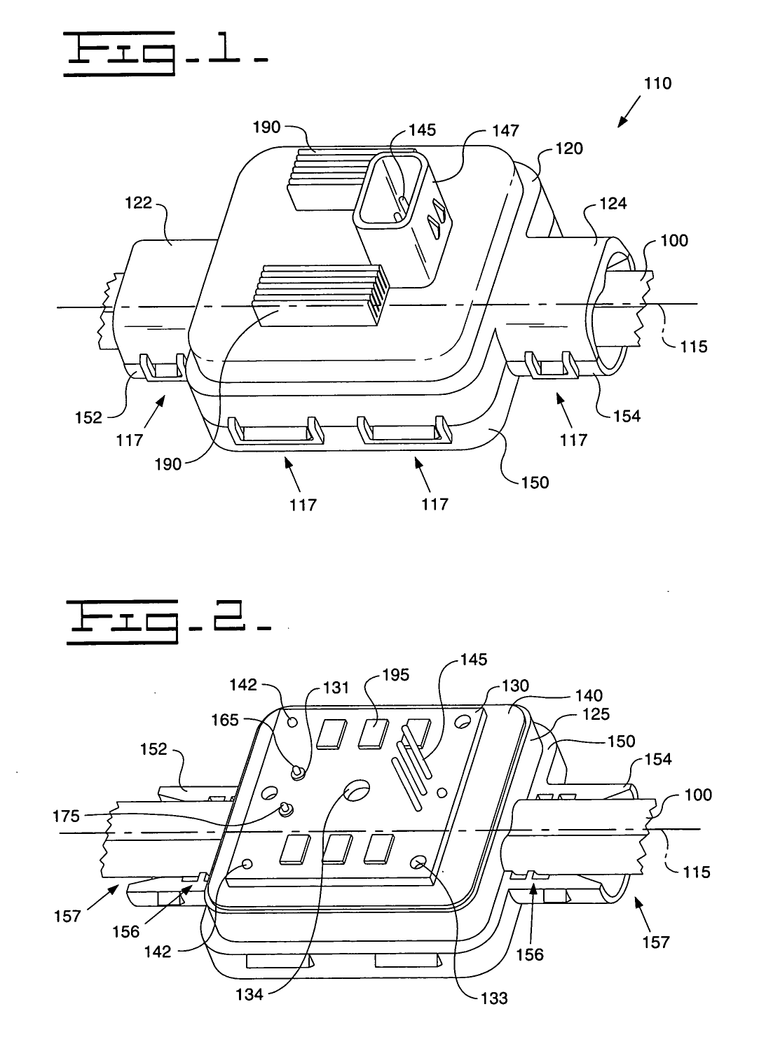

Referring to FIG. 1, there is shown a perspective view of a connector 110 according to one embodiment of the present disclosure. This connector 110 is shown fully assembled with a conductor 100 installed therein. The connector 110 may be connected to the conductor 100 at any location along the conductor 100 where it may be desired to connect a device (not shown). Although the conductor 100 is shown as being a two-wire configuration, the conductor 100 may also be a one-wire configuration with chassis ground. Alternatively, the conductor 100 may have configurations with more than two wires. The conductor 100 may be configured to transfer at least one of data and power.

The connector 110 may include a connector top housing 120 and a connector base housing 150. The conductor 100 is shown extending from top housing first and second ends 122,124 and corresponding base housing first and second ends 152,154. The conductor 100 may be configured to extend along a longitudinal axis 115. The top and base housings 120,150 may also be configured to extend along this same longitudinal axis 115. A connector interface or a device connector 147 is shown protruding from the top housing 120 transverse the longitudinal axis 115 of the conductor 100. Although a single device connector 147 is shown, there may be additional device connectors 147 extending from the connector 110 to accommodate additional connections to the conductor 110. The device connector 147 may also be configured to receive at least one connector pin 145 that may also extend transverse the longitudinal axis 115 of the conductor 100. While typical device connectors 147 may have three connector pins 145, the total number of connector pins 145 may be more or less than this.

The connector 110 may also be secured such that the top and base housings 120,150 provide a seal about the conductor 100. Although FIG. 1 depicts the top and base housings 120,150 being attached utilizing a plurality of mating clips 117, the top and base housings 120,150 may be attached in any number of ways, including, but not limited to, adhesive, screws, bolts, clips, and the like. Securing the top and base housings 120,150 about the conductor 100 by one of the above methods preferably maintains adequate connection in harsh environments.

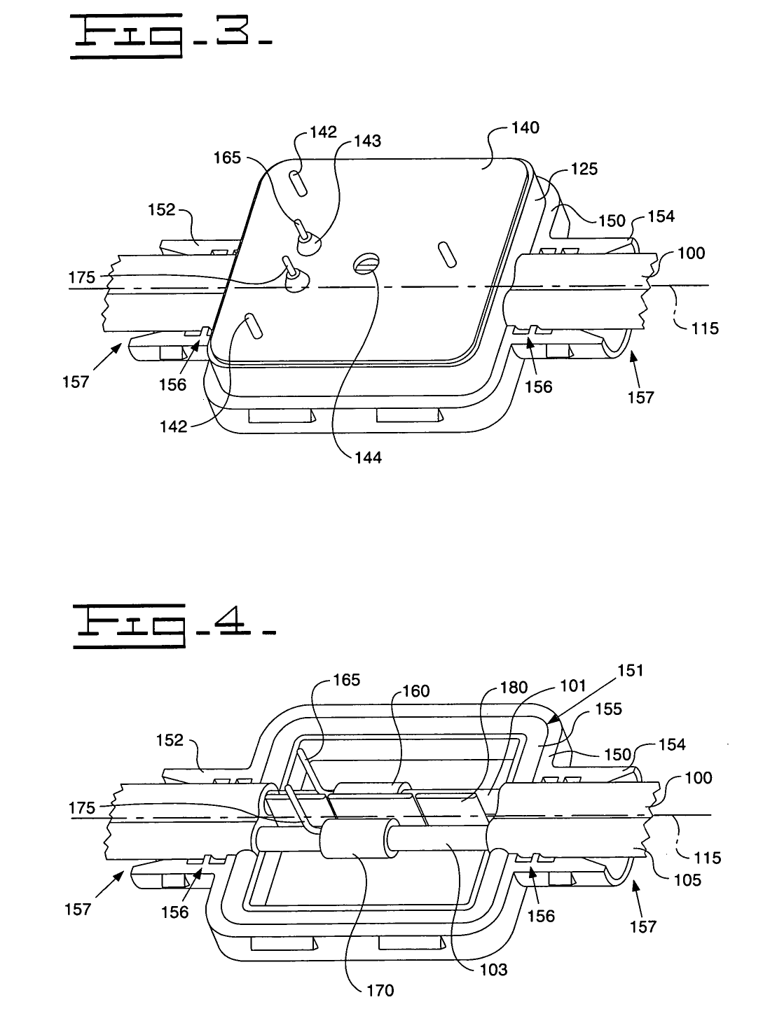

FIG. 2 is a perspective view of the connector 110 in FIG. 1 with the connector top housing 120 removed showing a circuit board 130, an intermediate layer 140, and a top housing seal 125. The intermediate layer 140 may be any layer providing separation between the top housing 120 and base housing 150, and may be known as a potting layer. The top housing 120, circuit board 130, potting layer 140, and top housing seal 125 may all come pre-assembled such that the top housing 120 may be connected to the base housing 150 in a single step. The top housing seal 125 may be seated in a groove (not shown) in the top housing 120. Additionally, a portion of the area between the potting layer 140 and the top housing 120 may be filled with a potting material (shown in FIG. 5 as 135) to surround the circuit board 130. The potting material 135 may be any material known in the art for use as a potting material 135. The potting layer 140 may then provide the separation between the top housing 120 and the base housing 150.

The circuit board 130 may have circuit board contacts 131 positioned to receive first and second contact prongs 165,175 through the potting layer 140. At least one connector pin 145 may also be attached to the circuit board to be received by the device connector 147. Locating apertures 133 may be configured in the circuit board 130 for receiving locating pins 142 from the potting layer 140 and locating pins (not shown) from the top housing 120. A potting aperture 134 may be located in the circuit board 130 for possible injection of the potting material 135.

Any of a variety of circuit boards 130 may be used with the connector 110. The circuit board 130 may contain a number of circuit board devices 195, such as, but not limited to, processors, transmitters, receivers, contact devices, transistors, etc. For mere electrical conveyance, a circuit board 130 may be omitted. In more complex electrical applications, the circuit board devices 195 may be heat generating such that they may require heat sinks 190, mounted external to the top housing 120, to conductively transfer heat from the circuit board 130.

FIG. 3 is a perspective view of the connector 110 in FIG. 1 with the connector top housing 120 and circuit board 130 removed showing the potting layer 140. The potting layer 140 may have locating pins 142 that may be received by locating apertures 133 in the circuit board 140. The potting layer 140 may also have a potting aperture 144 that lines up with the circuit board potting aperture 134 for injection of the potting material 135. The potting layer 140 may also have prong guides 143 to receive contact prongs 165,175 through the potting layer 140.

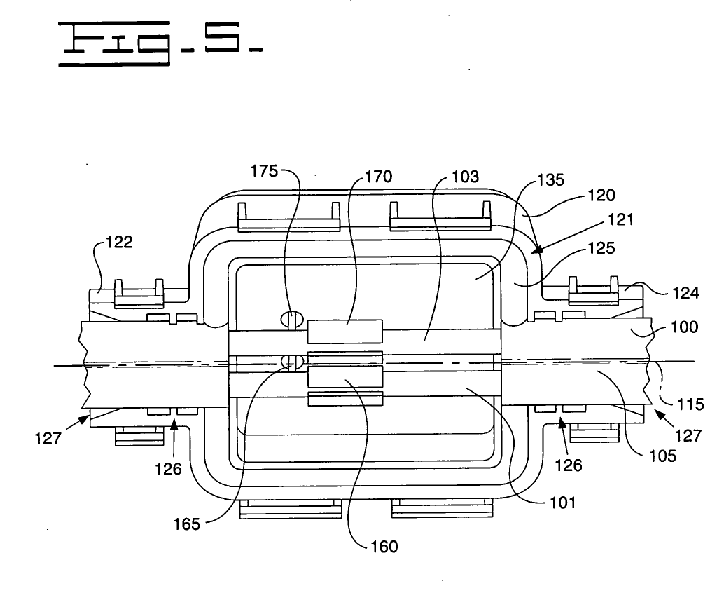

FIG. 4 is a perspective view of the connector 110 in FIG. 1 with the connector top housing 120, circuit board 130, and potting layer 140 removed showing the conductor 100 arranged along the longitudinal axis 115 of the connector 110. The base housing 150 is shown to have first and second ends 152,154. Each of the first and second ends 152,154 is shown to have a base conductor channel 157 to receive and locate the conductor 100. The base conductor channels 157 may have a base clamping portion 156 that may engage the insulation 105 of the conductor 100. Although the base clamping portion 156 is shown here as ribs or risers, the base clamping portion 156 may be configured using any of a number of ways known in the art to engage the conductor 100. Each of the base conductor channels 157 in the first and second ends 152,154 may also be outwardly flared about the conductor 100. The base housing 150 may also have a groove 151 to receive a base housing seal 155 and to engage the conductor 100.

As is shown in FIG. 4, a portion of the insulation 105 has been removed to expose the individual wires of the conductor 100. The conductor 100 may comprise a positive line 101 and a negative line 103. Each of the positive and negative lines 101,103 may be made from a finely stranded material, such as copper, aluminum, or other material. The positive and negative lines 101,103 may be disposed within an insulation 105 that electrically insulates and protectively surrounds the positive and negative lines 101,103. Sheathing (not shown) may be arranged about the insulation 105 for an additional layer of protection from abrasion as well as to prevent electromagnetic interference (EMI) or emissions. Alternatively, the insulation 105 and sheathing may be integrated as one component. Although FIG. 4 shows two wires, the conductor 100 may have more or less wires depending on the application and the power or data being conveyed over the conductor 100.

Removal of the insulation 105 may be accomplished in any of a number of ways such that conductor contacts 160,170 may be attached to the wires. The conductor contact 160,170 may be attached to each corresponding line 101,103 of the conductor 100 in any of a number of ways, such as crimping, welding, soldering, and the like. Each conductor contact 160,170 may have a corresponding prong 165,175 extending transverse the longitudinal axis 115. A conductor partition 180 may positioned in the base housing 150 between the positive and negative lines 101,103 of the conductor 100. Alternatively, connection of the connector 110 to the conductor 100 may occur without removing the insulation 105. This may require that the connector 110 have at least one prong (not shown) that may penetrate the insulation 105 to contact the at least one wire of the conductor 100. This prong (not shown) may assume the shape of a knife-like structure for easier penetration into the conductor 100, and may be configured to penetrate the conductor strands.

Properly securing the top and base housings 120,150 about the conductor 100 may equalize any compressive forces on the individual wires of the conductor 100 and may result in an overall stiffer region of the conductor 100. Having a stiffer region where the conductor contacts 160,170 attach to the conductor 100 may result in a reduction of fretting corrosion between the conductor contacts 160 and the individual wires of the conductor 50.

Ensuring a correct connection may include techniques such as clearly marking the conductor 100 and the conductor contacts 160 with positive or negative markings, color codes or other types of markings so that the correct polarity between the contacts is made. The top and base housings 120,150 and conductor 100 may also be designed such that the conductor 100 may fit into the connector 110 in only one orientation. Alternatively, the top and base housings 120,150 may be configured such that connection to the conductor 100 may be made with the positive and negative lines 101, 103 contacting either conductor contact 160,170, i.e., no initial attempt is made to connect via a certain polarity. In cases such as this, a polarity circuit (not shown) may be located on the connector 70 to sense voltage polarity and may either provide an indication of a correctly polarized connection or automatically reverse the polarity if not initially correct.

FIG. 5 is a perspective view of the connector 110 of FIG. 1 with the connector base housing 150 removed. The top housing 120 is shown to have first and second ends 122,124. Each of the first and second ends 122,124 is shown to have a top conductor channel 127 to receive and locate the conductor 100. The top conductor channels 127 may have a top clamping portion 126 that may engage the insulation 105 of the conductor 100. The top conductor channels 127 and clamping portions 126 may be configured to correspond to the base conductor channels 157 and clamping portions 156. Each of the top conductor channels 127 in the first and second ends 122,124 may also be outwardly flared about the conductor 100 corresponding to the base conductor first and second ends 152,154. The top housing 120 may also have a top housing seal 125 in a groove 121 that may correspond to the base housing seal 155 and may be configured to engage the base housing seal 155 and the conductor 100.

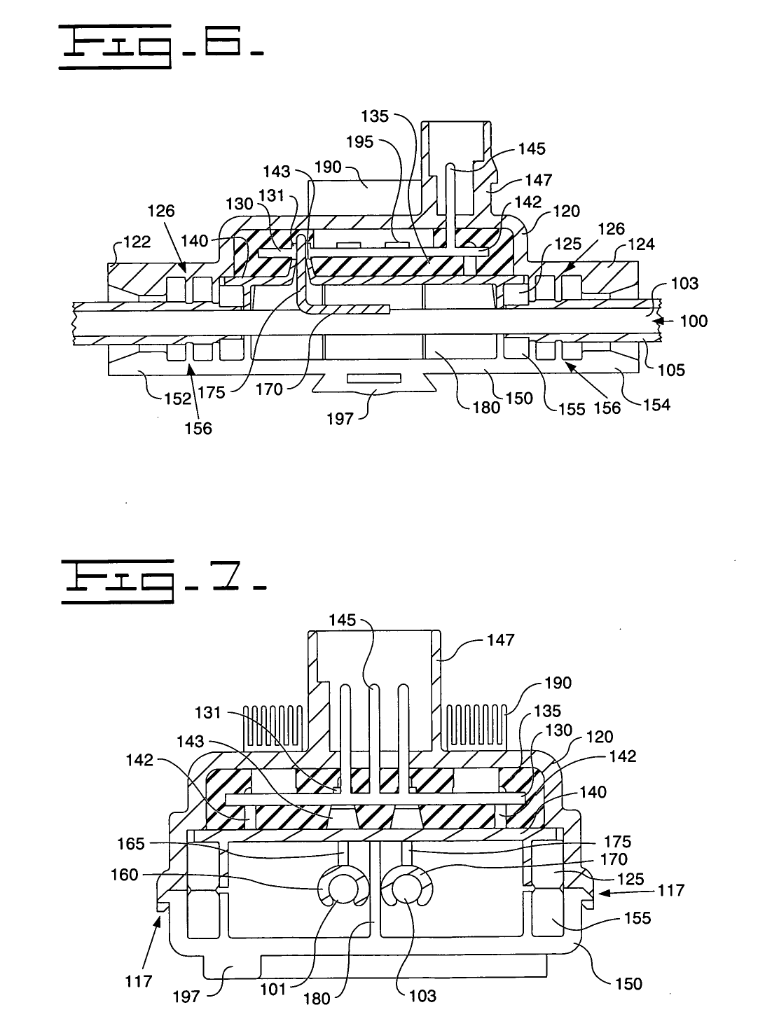

FIGS. 6 and 7 are respective cross section diagrams of the connector 110 of FIG. 1 parallel to and perpendicular to longitudinal axis 115 of the conductor 100. Although the potting material 135, as mentioned above, is shown to be present in the space between the top housing 120 and the potting layer 140, the potting material 135 may be used in any portion of the connector 100.

FIGS. 6 and 7 also show a connector mount 197 on a surface of the base housing 150. The connector 110 may be mounted to a machine or other structure in one of a number of ways in the art, including by adhesive, straps, mechanical means, and the like. This may depend on the materials used to construct the top and base housings 120,150 of the smart connector 110.

The connector 110 may connect to and make electrical contact with a device (not shown) by way of the device connector 147. The device connector 147, as shown here, may be integrated into the top housing 120. The device connector 147 may be connected to the device (not shown) via a mating connector arrangement (not shown) as may be suitable for the task. Alternatively, the device (not shown) may be connected to the connector 110 directly without any intermediate connector, for example by way of a pigtail.

### INDUSTRIAL APPLICABILITY

Embodiments of the present application are applicable to electrical systems where it is desired to connect a device (not shown) to a conductor 100. After a conductor 100 is arranged in a certain application, connectors 110 may be attached to the conductor 100 in locations near where devices (not shown) may desirably be located. Insulation 105 may be removed from a portion of the conductor 100 and conductor contacts 160 may be attached to each wire of the conductor 100. The wires of the conductor 100 may be positioned in a conductor base conductor channel 157 with a conductor partition 180 structured between the conductor contacts 160 attached to each wire. The top housing 120 may then be attached to the base housing 150 such that prongs 165 extending from the conductor contacts 160 may be operably received by a connector interface 147. This connection may be made without interrupting electrical continuity of the conductor 100 and may provide improved and consistent connection from the conductor 100 to the connector 110 and associated connector interface 147.

It will be apparent to those skilled in the art that various modifications and variations can be made in the system and method of the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1. A connector, comprising:
a base housing having a longitudinal axis, the base housing including:
a base conductor channel extending along the longitudinal axis and providing a through path for a conductor
a conductor partition extending along the longitudinal axis; and
at least one conductor contact having at least one corresponding prong extending transverse the longitudinal axis; and
a top housing having a top conductor channel corresponding to the base conductor channel and a connector interface operably connected to the at least one prong.

2. The connector of claim 1, wherein:
the top housing includes a circuit board positioned to receive the at least one prong, the circuit board having at least one connector pin; and
the connector interface is positioned to receive the at least one connector pin.

3. The connector of claim 1, wherein the conductor contact is configured about a portion of the conductor.

4. The connector of claim 1, wherein the base housing and the top housing provide a seal about the conductor when the base housing is connected to the top housing.

5. The connector of claim 1, wherein the top and base conductor channels each have a first and a second end, at least one of the first and second ends being flared outwardly.

6. The connector of claim 5, wherein at least one of the top and base conductor channels include a clamping portion.

7. The connector of claim 1, wherein at least one of the top and base conductor channels have a clamping portion.

8. The connector of claim 7, wherein the clamping portion engages the conductor when the base housing is connected to the top housing.

9. The connector of claim 2, wherein the top housing further includes a potting layer separating the top housing from the base housing, the potting layer having at least one prong guide.

10. The connector of claim 9, wherein the circuit board is positioned between the top housing and the potting layer to receive the at least one prong through the at least one prong guide.

11. The connector of claim 10, wherein the space between the potting layer and the top housing contains a potting material.

12. The connector of claim 2, wherein the circuit board includes a processor.

13. The connector of claim 12, wherein the circuit board further includes at least one of a transmitter, a receiver, and a contact device.

14. The connector of claim 2, wherein the top housing further includes a heat sink, the heat sink being operably connected to the circuit board through the top housing.

15. The connector of claim 4, wherein an electrical connection is made at the connector interface.

16. The connector of claim 1, wherein the connector interface is configured to be connected to the device at a device interface.

17. A method for attaching a connector to a conductor, comprising:
attaching a conductor contact to each of at least one conductor wire, the conductor contact having a prong extending transverse a longitudinal axis of the conductor;
positioning the conductor in a base conductor channel of a base housing located along the longitudinal axis;
separating each conductor wire from each other conductor wire with a conductor partition; and
attaching a top housing to the base housing such that each prong extends through the top housing to a connector interface.

18. The method as set forth in claim 17, further comprising:
removing a portion of an insulation from each conductor wire.

19. The method as set forth in claim 17, further comprising:
providing a seal about the conductor as the top housing is attached to the base housing.

20. The method as set forth in claim 17, further including:
separating the top housing from the base housing with a potting layer.

21. The method as set forth in claim 20, further comprising:
positioning a circuit board between the top housing and the potting layer.

22. The method as set forth in claim 21, wherein positioning the circuit board further includes:
positioning the circuit board to receive each prong; and
arranging at least one connector pin on the circuit board to be received by the connector interface.

23. The method as set forth in claim 20, further including:
inserting a potting material in a portion of the space between the top housing and the potting layer.
